(19) United States
(12) Patent Application Publication
(10) Pub. No.: US 2023/0106711 A1
(43) Pub. Date: Apr. 6, 2023

(54) METHOD FOR BURNING CARBON-CONTAINING MATERIAL IN A PFR SHAFT FURNACE

(71) Applicants: Maerz Ofenbau AG, Zurich (CH); thyssenkrupp AG, Essen (DE)

(72) Inventors: Hannes PIRINGER, Beinwil am See (CH); Patrick BUCHER, Schoenenwerd (CH); Fernand DIDELON, Bettembourg (LU)

(73) Assignees: Maerz Ofenbau AG, Zurich (CH); thyssenkrupp AG, Essen (DE)

(21) Appl. No.: 17/802,627

(22) PCT Filed: Feb. 23, 2021
(86) PCT No.: PCT/EP2021/054475

§ 371 Date: Aug. 26, 2022

(30) Foreign Application Priority Data
Feb. 26, 2020 (CN) 202010118637.6
Feb. 26, 2020 (CN) 202020210805.X
Feb. 26, 2020 (DE) 10 2020 202 481.2
Feb. 26, 2020 (LU) LU101654

(51) Int. Cl. F27B 1/04; F27B 1/16; F27D 99/00

(52) U.S. Cl. CPC F27B 1/04; F27B 1/16; F27D 99/0003

(57) ABSTRACT

A method can be used to burn and cool material in a parallel flow-counter flow regenerative shaft kiln having two shafts that are operated alternately as a burning shaft and a regenerative shaft. The material flows through a preheating zone, a burning zone, and a cooling zone to a material outlet. Fuel is supplied in or above the preheating zone, and thus fuel is heated in the preheating zone prior to entering the burning zone. Further, a parallel flow-counter flow regenerative shaft kiln for burning and cooling material may have two shafts that can be operated alternately as a burning shaft and a regenerative shaft. Each shaft has, in a flow direction, a preheating zone for preheating material, a burning zone for burning material, and a cooling zone for cooling material. A fuel inlet that admits fuel into each shaft is arranged above or inside the preheating zone.

The invention relates to a method for burning carbon-containing material in a parallel flow-counter flow regenerative shaft kiln (PFCFR shaft kiln), and also to a PFR shaft kiln.

A PFR shaft kiln of this kind which is known for example from WO 2011/072894 A1 has two vertical, parallel shafts which operate in cycles, wherein burning is performed only in one shaft, the respective burning shaft, while the other shaft operates as a regenerative shaft. The burning shaft is supplied with oxidation gas in parallel flow with the material and fuel, wherein the resultant hot exhaust gases, together with the heated cooling air which is supplied from below, are conducted via the flow transfer channel into the exhaust gas shaft, where the exhaust gases are conducted away towards the top in counter flow to the material and the material is preheated in the process. The material is usually supplied into the shaft from above together with the oxidation gas, wherein fuels are injected in the burning zone.

In each shaft, the material to be burned usually passes through a preheating zone for preheating the material, a burning zone which is subsequent thereto and in which the material is burned, and a cooling zone which is subsequent thereto and in which cooling air is supplied to the hot material.

During a cycle, which has a duration of for example 10-15 min., the material to be burned is discharged continuously via discharge devices on the two shafts. The material column falls in a uniform manner in the shafts. Thereafter, the kiln is reversed, such that the shaft which previously operated as a burning shaft becomes the regenerative shaft, and the shaft which previously operated as a regenerative shaft in turn becomes the burning shaft.

Such a PFR shaft kiln is for example operated with fuel gases up to a calorific value of approximately 3.3 MJ/Nm³, wherein fuel gases with a calorific value of less than 6.6 MJ/Nm³ entail considerable disadvantages in the operation of the PFR shaft kiln. By way of example, there is a high proportion of non-combustible constituents in fuel gases with a calorific value of less than 6.6 MJ/Nm³. There is thus a relatively large amount of fuel gas during operation of the PFR shaft kiln, which, together with the combustion air and lime cooling air, results in a relatively large amount of exhaust gas. The relatively large amount of exhaust gas contains surplus heat which can no longer be absorbed by the limestone bed in the preheating zone of the PFR shaft kiln. As a result, the exhaust gas temperature increases from about 100° C. to about 300° C.

The higher exhaust gas temperature and the higher volume of exhaust gas lead to higher heat losses, and therefore when a PFR shaft kiln, embodied according to the current prior art, is fired with gases having a calorific value of only 3.3 MJ/Nm3, said PFR shaft kiln requires about 20% more thermal energy or fuel than a PFR shaft kiln fired with natural gas.

Owing to the higher volume of exhaust gas, the pressure loss of a PFR shaft kiln which is embodied according to the current prior art, during operation with fuel gases with a calorific value of only 3.3 MJ/Nm3, increases by about 35% compared with a natural gas-fired PFR shaft kiln. Equally, there is consequently a higher electrical energy requirement in order to compress the fuel gases and the process air.

EP 1 634 026 B1 discloses a method which reduces the disadvantages mentioned above. However, said method has the disadvantage that it requires a large and expensive hot gas heat exchanger, which, owing to the high operating temperatures, could also become clogged with dust.

Proceeding therefrom, it is an object of the present invention to specify a method for operating a PFR shaft kiln, in which the aforementioned disadvantages are overcome.

Said object is achieved according to the invention by way of a method having the features of independent Method claim 1 and by way of an apparatus having the features of independent Apparatus claim 9. Advantageous developments will become apparent from the dependent claims.

According to a first aspect, the invention comprises a method for burning and cooling material, such as carbonate rocks, in a parallel flow-counter flow regenerative shaft kiln having two shafts which are operated alternately as a burning shaft and as a regenerative shaft, wherein the material flows through a preheating zone, at least one burning zone, and a cooling zone to a material outlet. The fuel is supplied inside or above the preheating zone into the respective shaft, and therefore the fuel is heated in the preheating zone prior to entry into the burning zone. In this context, “above the preheating zone” is understood to mean upstream of the preheating zone in the direction of flow of the material. Preferably, the fuel is supplied exclusively inside or above the preheating zone. The fuel is for example a fuel gas, such as blast furnace gas, with a calorific value of less than 6.6 MJ/Nm³.

This permits a uniform distribution of gas and temperature in the shafts, which is a prerequisite for the generation of a good and uniform product quality.

The parallel flow-counter flow regenerative shaft kiln for burning and cooling material, such as carbonate rocks, has at least two shafts which are preferably arranged parallel to one another and in a vertical manner. The shafts can be operated alternately as a burning shaft and as a regenerative shaft, wherein each shaft has, in the direction of flow of the material, a preheating zone for preheating the material, a burning zone for burning the material and a cooling zone for cooling the material. Each shaft preferably has a material inlet for admission of material to be burned into the shaft, wherein the material inlet is located in particular at the upper end of the respective shaft, with the result that the material falls into the respective shaft due to gravity. The material to be burned is for example supplied at the same height level as the inlet of the fuel into the respective shaft. The fuel inlet is arranged above or inside the preheating zone. In particular, the fuel is supplied at the upper end of the preheating zone, and therefore the fuel, in particular the fuel gas, passes completely through the entire preheating zone prior to entry into the burning zone.

The shafts are preferably connected to one another in terms of gas technology via a gas channel, such that gas can flow from one shaft to the other shaft. The gas channel has the function of a flow transfer channel between the two shafts.

The material to be burned is in particular limestone or dolomite rock.

According to a first embodiment, oxidation gas is supplied into the burning zone. Preferably, the oxidation gas is supplied exclusively into the burning zone and not into the preheating zone. The means for introduction of the oxidation gas are arranged in particular inside the burning zone. Oxidation gas, such as, for example air, oxygen-enriched air or an oxygen-containing gas with a proportion of oxygen of approximately 80% or virtually pure oxygen, is preferably introduced in the direction of flow of the material inside the preheating zone, at the entrance to the burning zone or inside the burning zone. According to a further embodiment, oxidation gas is introduced into the burning zone via a multiplicity of lances. By way of example, the oxidation gas is introduced into the respective shaft via the lances, wherein the lances are in particular L-shaped, are at a uniform spacing from one another and extend from the preheating zone into the burning zone, and therefore the oxidation gas is preferably heated inside the lances in the preheating zone and exits the lances in the burning zone. This affords the advantage of targeted introduction of oxidation gas into the burning zone, in which the combustion of the fuel gas takes place.

It is likewise conceivable for the oxidation air to be introduced into the shaft via at least one or a multiplicity of slots in the shaft wall. By way of example, the slots extend substantially horizontally, in particular transversely with respect to the material flow direction. The slots form inlets for admission of the oxidation air into the respective shaft and are for example all arranged at the same height level and are in particular arranged at a uniform spacing from one another. The advantage of such an embodiment is that a thin, curtain-like oxidation gas stream flows downwards, in the material flow direction, on or in the vicinity of the shaft inner wall, with the result that the CO in the fuel gas is completely combusted. The above-described lances can be provided as an alternative to or in addition to the slots.

Preferably, inlets for admission of oxidation gas are provided at a plurality of positions inside a shaft. By way of example, the inlets are embodied in slot form in the shaft wall or as lances. Such inlets are for example provided at a plurality of positions, which are successive in the material flow direction, inside the burning zone. It is likewise conceivable for inlets to be provided inside the preheating zone, in particular at the boundary between the preheating zone and the burning zone.

According to a further embodiment, the fuel, in particular the fuel gas, has a calorific value of less than 6.6 MJ/Nm³, in particular 1 MJ/Nm³ to 7 MJ/Nm³, preferably 2 MJ/Nm³ to 4 MJ/Nm³, most preferably 3.3 MJ/Nm³.

According to a further embodiment, arranged at the transition between the preheating zone and the burning zone or inside the preheating zone or inside the burning zone is a flow resistance for generating a gas volume without material to be burned, wherein the oxidation gas is introduced inside said gas volume without material to be burned. The flow resistance is for example a bar which is arranged transversely with respect to the material flow direction. A gas volume without material to be burned, in which the oxidation gas is introduced, is formed below the bar. This affords the advantage of uniform introduction and distribution of the oxidation gas into the respective shaft.

According to a further embodiment, the oxidation gas is introduced into an annular space which is arranged around the burning zone, in particular around the transition between the preheating zone and the burning zone. The annular space is preferably arranged concentrically around the preheating zone and/or the burning zone of one or all of the shafts of the PFR shaft kiln. The annular space represents a gas volume without material to be burned, in which the oxidation gas is advantageously introduced.

According to a further embodiment, a respective shaft is operated as a burning shaft over the length of time of a burning cycle, and the following method steps are performed during a burning cycle:
a. supplying fuel through the fuel inlet into the burning shaft over the time interval of a fuel supply time,
b. supplying an inert gas through the fuel inlet into the burning shaft over the time interval of a preliminary flushing time,
c. supplying a low-oxygen gas through the fuel inlet into the burning shaft over the time interval of a subsequent flushing time,
d. reversing the kiln operation, wherein the functions of the burning shaft and of the regenerative shaft are reversed.

The method steps described above are preferably performed successively in the stated order.

The inert gas is for example nitrogen or carbon dioxide. The inert gas is preferably introduced into the burning shaft via the fuel inlets above or inside the preheating zone, and, as a result, the fuel gas is preferably pushed downwards in the direction of flow of the material. After the preliminary flushing time, there is preferably no longer any ignitable gas mixture inside or above the preheating zone of the burning shaft. The subsequent flushing time preferably temporally follows the preliminary flushing time, wherein a low-oxygen gas, such as, for example, kiln exhaust gas, is introduced into the burning shaft at the fuel inlets of the burning shaft, as a result of which the already diluted fuel gas is preferably pushed, in the direction of flow of the material, further downwards inside the burning shaft. At the end of the subsequent flushing time, the concentration of environmentally harmful gases inside and above the preheating zone of the burning shaft is preferably so low that the reversal with respect to the other shaft, operated as a regeneration shaft, can be initiated.

This affords the advantage that the fuel gas which has not yet been combusted upon reversal of the mode of operation, or at the end of a cycle, wherein the operation of the shafts as burning shaft or regeneration shaft is swapped, is preferably completely combusted inside the burning zone of the burning shaft before the function of the kiln shafts is swapped, in order to minimize the risk of explosion and to prevent impermissible emissions into the atmosphere.

According to a further embodiment, during the preliminary flushing time and/or the subsequent flushing time, an oxidation gas is introduced into the burning shaft via the lances. As a result, the combustible gases which flow from above into the burning zone during the preliminary and subsequent flushing times are completely combusted.

The invention also relates to a parallel flow-counter flow regenerative shaft kiln for burning and cooling material, such as carbonate rocks, having two shafts which can be operated alternately as a burning shaft and as a regenerative shaft, wherein each shaft has, in the direction of flow of the material, a preheating zone for preheating the material, a burning zone for burning the material and a cooling zone for cooling the material. A fuel inlet for admission of fuel into the respective shaft is arranged above or inside the preheating zone. The advantages and refinements described above with reference to the method for operating the PFR shaft kiln likewise apply to the PFR shaft kiln in an equivalent manner in terms of apparatus.

According to one embodiment, a multiplicity of lances or slots in the shaft wall for introduction of oxidation gas are arranged inside the burning zone. The lances extend, for example, from the preheating zone into the burning zone, such that the outlet of the lances is arranged inside the burning zone.

According to a further embodiment, a multiplicity of gas lances or slots in the shaft wall for introduction of oxidation gas are arranged inside the burning zone. As an alternative to or in addition to the lances described above, the gas lances are preferably arranged inside the burning zone and/or the cooling zone and/or inside a gas channel for connection of the shafts, wherein the gas lances are arranged in particular downstream of the lances in the direction of flow of the material. The gas lances are for example arranged inside the burning zone and/or the cooling zone at a uniform spacing from one another. An introduction of oxidation gas at a further downstream region inside the burning zone and/or the cooling zone ensures complete combustion of the fuel inside the PFR shaft kiln.

According to a further embodiment, arranged at the transition between the preheating zone and the burning zone is a flow resistance for generating a gas volume without material to be burned. According to a further embodiment, means are arranged for introducing oxidation gas into the gas volume without material to be burned.

According to a further embodiment, each shaft has a respective gas collection channel which is configured in the form of an annular space, and wherein the gas collection channels of the shafts are connected to one another in terms of gas technology via a gas channel. The PFR shaft kiln preferably has a gas channel for the gas-technological connection of the shafts, wherein the gas channel for example connects the cooling zones and/or the burning zones of the shafts to one another at a region. The gas collection channel is preferably arranged in the form of an annular space around the cooling zone and/or the burning zone of the respective shaft.

This affords the advantage of a more uniform distribution of gas and temperature in the shafts and of a resultant better product quality with a low amount of harmful emissions. A further advantage is that non-combusted fuel gases, which flow out of the preheating zone into the gas channel, together with the cooling air which is supplied to the burning shaft, are subsequently combusted there in a better manner since the gas channel volume is substantially greater.

### DESCRIPTION OF THE DRAWINGS

The invention is explained in more detail in the following text on the basis of a number of exemplary embodiments with reference to the attached figures.

FIG. 1 shows a schematic illustration of a PFR shaft kiln in a longitudinal and cross-sectional view according to one exemplary embodiment.

FIG. 2 shows a schematic illustration of a PFR shaft kiln in a longitudinal and cross-sectional view according to a further exemplary embodiment.

FIG. 3 shows a schematic illustration of a PFR shaft kiln in a longitudinal and cross-sectional view according to a further exemplary embodiment.

FIG. 4 shows a schematic illustration of a PFR shaft kiln in a longitudinal sectional view according to a further exemplary embodiment.

FIG. 5 shows a schematic illustration of the temporal sequences inside the shaft operated as a burning shaft over a burning cycle according to one exemplary embodiment.

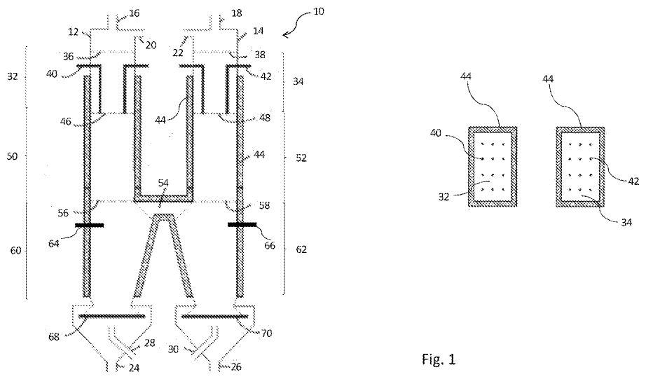

FIG. 1 shows a PFR shaft kiln 10 having two parallel and vertically oriented shafts 12, 14. Each shaft 12, 14 has a respective material inlet 16, 18 for admission of material to be burned into the respective shaft 12, 14 of the PFR shaft kiln. By way of example, the material inlets 16, 18 are arranged at the upper end of the respective shaft 12, 14, and therefore the material falls though the material inlet 16, 18 into the shaft 12, 14 due to gravity.

Each shaft 12, 14 furthermore has, at its upper end, a fuel inlet 20, 22 for admission of fuel gases. By way of example, the fuel inlets 20, 22 are arranged at the same height level as the material inlets 16, 18.

At the lower end of each shaft 12, 14, there is a material outlet 24, 26 for letting out the material which has been burned in the respective shaft 12, 14. Each shaft 12, 14 has, at its lower end, a cooling air inlet 28, 30 for admission of cooling air into the respective shaft 12, 14. During operation of the PFR shaft kiln 10, the material to be burned flows from the top to the bottom through the respective shaft 12, 14, wherein the cooling air flows from the bottom to the top, in counter flow to the material, through the respective shaft. The kiln exhaust gas is conducted away, for example, through the material inlet 16, 18 or through the fuel inlet 20, 22 or a gas outlet separate therefrom out of the respective shaft 12, 14.

The preheating zone 32, 34 of the respective shaft 12, 14 adjoins in the direction of flow of the material below the material inlets 16, 18 and the fuel inlets 20, 22. In the preheating zone 32, 34, the material and the fuel are preferably preheated to approximately 700° C. Preferably, the respective shaft 12 is filled with material to be burned as far as the upper boundary surface 36, 38 of the preheating zone 32, 34. The material and the fuel, in particular the fuel gas, are preferably supplied above the preheating zone 32, 34 into the respective shaft. At least a part of the preheating zone 32, 34 and that part of the respective shaft 12, 14 which adjoins it in the direction of flow of the material are surrounded with a refractory lining 44, for example.

A multiplicity of lances 40, 42 are optionally arranged in the preheating zone 32, 34 and serve in each case as an inlet for an oxidation gas, such as, for example, oxygen-containing air, in particular oxygen-enriched air or a gas with a proportion of oxygen of approximately 80% or virtually pure oxygen. FIG. 1 likewise shows a cross-sectional view of the PFR shaft kiln 10 at the height level of the lances 40, 42. By way of example, twelve lances 40, 42 are arranged in each shaft 12, 14 at a substantially uniform spacing from one another. By way of example, the lances 40, 42 have an L shape and preferably extend in a horizontal direction into the respective shaft 12, 14 and in a vertical direction, in particular in the direction of flow of the material, inside the shaft 12, 14. The ends of the lances 40, 42 of a shaft 12, 14 are preferably arranged at the same height level. Preferably, the plane on which the lance ends 40, 42 are arranged is in each case the lower boundary surfaces 46, 48 of the respective preheating zone 32, 34. As an alternative to or in addition to the lances 40, 42, it is also possible for slots in the shaft wall to form inlets for admission of oxidation air into the shaft.

The burning zone 50, 52 adjoins the preheating zone 32, 34 in the direction of flow of the material. In the burning zone, the fuel is combusted and the preheated material is burned at a temperature of approximately 1000° C. The oxidation gas which is introduced through the lances 40, 42 into the burning zone 50, 52 permits the combustion of the fuel in the burning zone 50, 52. A multiplicity of gas lances 64, 66 are optionally provided inside the burning zone 50, 52 and/or the cooling zone 60, 62, said gas lances extending into the burning zone 50, 52 and/or the cooling zone 60, 62 at a position downstream of the above-described lances 40, 42 in the direction of flow of the material and serving for the admission of oxidation gas into the burning zone 50, 52 and/or the cooling zone 60, 62. The gas lances 64, 66 are for example arranged in a lower region of the burning zone close to the lower boundary surface 56, 58 of the burning zone 50 and/or in the upper region of the cooling zone 60, 62 close to the lower boundary of the burning zone 50, 52. It is likewise conceivable for the gas lances 64, 66, as illustrated in FIG. 1, to be provided inside the cooling zone 60, 62.

The PFR shaft kiln 10 furthermore has a gas channel 54 for the gas-technological connection of the two shafts 12, 14 to one another. The lower boundary surface 56, 58 of the burning zone 50, 52, in particular the end of the burning zone 50, 52, is preferably arranged at the upper height level of the gas channel 54. The burning zone 50, 52 is adjoined in the direction of flow of the material in each shaft 12, 14 by a cooling zone 60, 62 which extends as far as the material outlet 24, 26 or the discharge device 68, 70 of the respective shaft. The material is cooled inside the cooling zone 60, 62 to approximately 100° C.

A discharge device 68, 70 is arranged at the material-outlet-side end of each shaft 12, 14. The discharge devices 68, 70 for example comprise horizontal plates which allow the material to pass through laterally between the discharge devices 68, 70 and the housing wall of the PFR shaft kiln. The discharge device 68, 70 is preferably embodied as a push table or rotary table or as a table with push-type scraper means. This permits a uniform throughput speed of the material to be burned through the kiln shafts 12, 14.

During operation of the PFR shaft kiln 10, a respective one of the shafts 12, 14 is active, with the respectively other shaft 12, 14 being passive. The active shaft 12, 14 is referred to as burning shaft and the passive shaft 12, 14 is referred to as regenerative shaft. The PFR shaft kiln 10 is operated in cycles; a typical number of cycles being 75 to 150 cycles per day. After the cycle time has expired, the function of the shafts 12, 14 is swapped. This operation is continuously repeated. Material such as limestone or dolomite rock is supplied into the shaft 12, 14 which is in each case operated as a burning shaft in an alternating manner via the material inlets 16, 18. In the shaft 12, 14 which is operated as a burning shaft, a fuel gas, such as, for example, blast furnace gas, is introduced into the burning shaft via the fuel inlet 20, 22, wherein the fuel inlet 20, 22 serves as an exhaust gas outlet in the regenerative shaft. The fuel gas is heated in the preheating zone 32, 34 of the burning shaft to a temperature of approximately 700° C.

By way of the lances 40, 42, an oxidation gas, for example air, oxygen-enriched air or oxygen, but preferably an oxidation gas with a high oxygen content, most preferably an oxidation gas with an oxygen content of more than 80% by volume, is supplied in the burning shaft. As a result of this method, the amounts of gas which flow through the burning zone 50, 52 and through the preheating zone 32, 34 of the regenerative shaft are reduced considerably, wherein the gases flowing through the preheating zone 32, 34 of the regenerative shaft contain no surplus heat and preferably have an exhaust gas temperature of about 100° C. Owing to the relatively small amounts of gas, the pressure loss of the entire kiln is reduced considerably, which leads to considerable savings in terms of electrical energy at the process gas compressors.

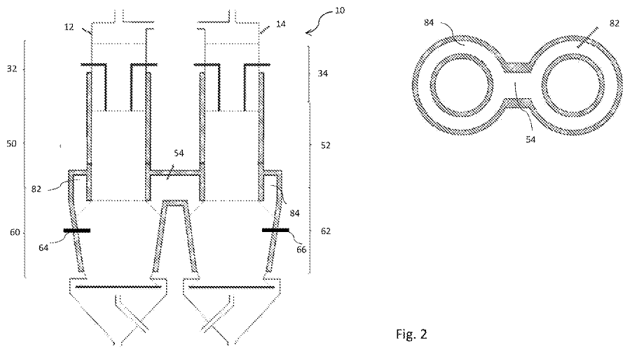

FIG. 2 shows a further exemplary embodiment of a PFR shaft kiln 10 having two parallel shafts 12, 14, wherein the PFR shaft kiln corresponds substantially to the PFR shaft kiln 10 of FIG. 1. Some of the reference designations which have been explained already in FIG. 1 have been omitted for the sake of clarity. In contrast to the PFR shaft kiln 10 of FIG. 1, the PFR shaft kiln 10 of FIG. 2 has a round cross section. However, all cross-sectional shapes such as round, oval, rectangular or polygonal are conceivable. Furthermore, the PFR shaft kiln 10 of FIG. 2 has a gas collection channel 82, 84, which is configured in the form of an annular space. The gas collection channel preferably extends in a circumferential manner around the lower region of the burning zone 50, 52, in particular below the gas lances 64, 66. Each shaft 12, 14 has a respective gas collection channel 82, 84, wherein the gas collection channels 82, 84 are arranged at the height level of the gas channel 54 for connection of the two shafts 12, 14. The gas collection channels 82, 84 of the two shafts 12, 14 are in particular connected to one another in terms of gas technology via the gas channel 54. In particular, the gas collection channel 82 is connected in terms of gas technology to the cooling zone 60, 62, with the result that the cooling gas flows at least partially into the gas collection channel 82.

This construction advantageously leads to a more uniform distribution of gas and temperature in the shafts 12, 14 and, as a result, to better product quality and to lower harmful emissions. A further advantage of this construction is that, if necessary, non-combusted fuel gases, which flow out of the preheating zone 32, 34 into the gas channel 54, together with the cooling air which is supplied to the burning shaft, are subsequently combusted there in a better manner since the gas channel volume is substantially greater.

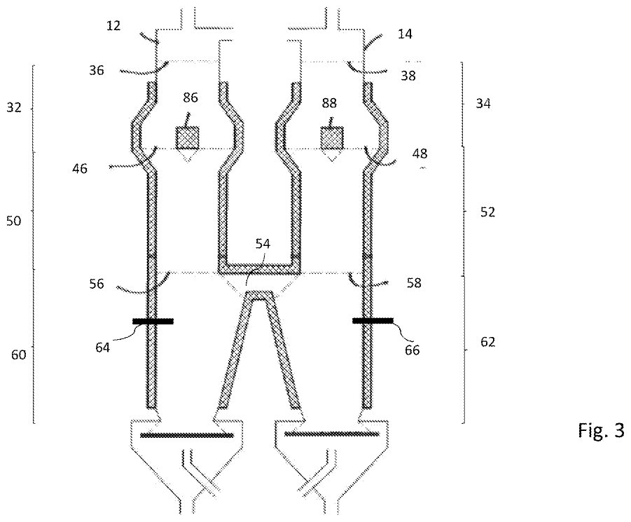

FIG. 3 shows a further exemplary embodiment of a PFR shaft kiln 10 having two parallel shafts 12, 14, wherein the PFR shaft kiln corresponds substantially to the PFR shaft kiln 10 of FIG. 1. Some of the reference designations which have been explained already in FIG. 1 have been omitted for the sake of clarity. In contrast to the PFR shaft kiln 10 of FIG. 1, the PFR shaft kiln 10 of FIG. 3 has no lances 40, 42. Merely the gas lances 64, 66 inside the burning zone 50, 52 and/or the cooling zone 60, 62 are provided. Furthermore, the PFR shaft kiln 10 of FIG. 3 has, in each preheating zone 32, 34, a flow resistance which is oriented transversely with respect to the material flow direction, in particular a bar 86, 88. Oxidation gas, such as, for example, air, oxygen-enriched air, oxygen or an oxidation gas with a proportion of oxygen of at least 80%, is introduced below the bar 86, 88.

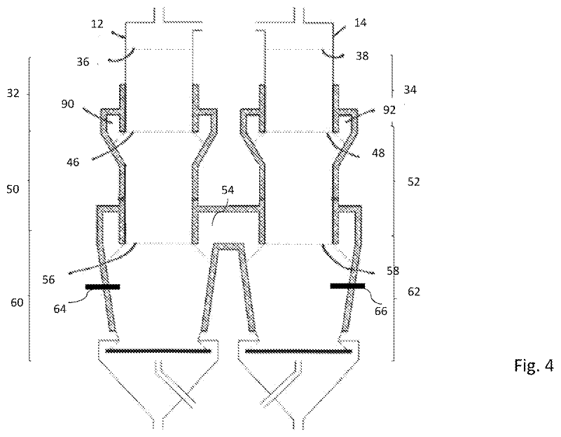

FIG. 4 shows a further exemplary embodiment of a PFR shaft kiln 10 having two parallel shafts 12, 14, wherein the PFR shaft kiln corresponds substantially to the PFR shaft kiln 10 of FIG. 2. Some of the reference designations which have been explained already in FIG. 2 have been omitted for the sake of clarity. In contrast to the PFR shaft kiln 10 of FIG. 2, the PFR shaft kiln 10 of FIG. 4 has no lances 40, 42. The PFR shaft kiln 10 of FIG. 4 has a further annular space 90, 92 which extends around the lower region of a respective preheating zone 32, 34. The annular space 90, 92 is connected in terms of gas technology to the burning zone and for example represents a region in which no material to be burned is present. An oxidation gas, for example air or oxygen-enriched air or oxygen, but preferably an oxidation gas with a high oxygen content, most preferably an oxidation gas with an oxygen content of more than 80% by volume, is preferably supplied inside the annular space 90, 92.

By way of example, the PFR shaft kilns of FIGS. 1 to 4 each have two shafts 12, 14. It is likewise conceivable for three or more interconnected shafts to be provided in a PFR shaft kiln. The gas lances 64, 66 illustrated in FIGS. 1 to 4 can for example be arranged, in addition to or as an alternative to the illustrated gas lances, inside the gas channel 54, such that oxidation gas is introduced directly into the gas channel.

Each of the shafts 12, 14 of the PFR shaft kiln 10 is operated as a burning shaft over a burning cycle time and subsequently as a regeneration shaft over a regeneration cycle time.

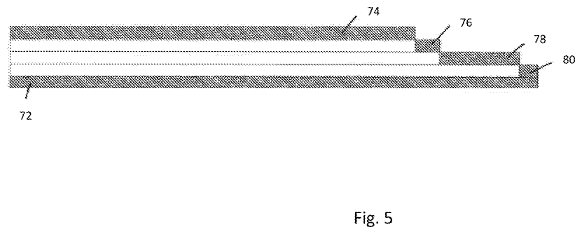

The temporal sequences within a burning cycle are illustrated in FIG. 5. The burning cycle time 72 is divided into the fuel supply time 74, the preliminary flushing time 76, the subsequent flushing time 78 and the reversal time 80. In the preliminary flushing time 76, directly after the supply of fuel has been turned off, an inert gas, such as, for example, nitrogen or carbon dioxide, is supplied to the fuel inlets 20, 22 on the burning shaft and, as a result, the fuel gas is preferably pushed downwards in the direction of flow of the material. At the end of the preliminary flushing time 76, there is preferably no longer any ignitable gas mixture inside or above the preheating zone 32, 34 of the burning shaft. The subsequent flushing time 78 temporally follows the preliminary flushing time 76, wherein a low-oxygen gas, such as, for example, kiln exhaust gas, is introduced into the burning shaft at the fuel inlets 20, 22 of the burning shaft, as a result of which the already diluted fuel gas is preferably pushed, in the direction of flow of the material, further downwards inside the burning shaft. At the end of the subsequent flushing time 78, the concentration of environmentally harmful gases inside and above the preheating zone 32, 34 of the burning shaft is preferably so low that the reversal with respect to the other shaft 12, 14, operated as a regeneration shaft, can be initiated. Preferably, during the preliminary flushing time 76 and the subsequent flushing time 78, an oxidation gas is introduced into the burning shaft in particular in a continuous manner via the lances 40, 42, with the result that the combustible gases which flow from above into the burning zone 50, 52 during the preliminary and subsequent flushing times are completely combusted.

The above-described method for operating the PFR shaft kiln 10 affords the advantage that the fuel gas which has not yet been combusted upon reversal of the mode of operation, or at the end of a cycle, wherein the operation of the shafts 12, 14 as burning shaft or regeneration shaft is swapped, is preferably completely combusted inside the burning zone 50, 52 of the burning shaft before the function of the kiln shafts is swapped, in order to minimize the risk of explosion and to prevent impermissible emissions into the atmosphere.

It is likewise possible for the above-described PFR shaft kiln 10, in particular in the start-up phase, to be operated in such a way that oxidation gas is supplied through the fuel inlets 20, 22 into the respective shaft 12, 14, wherein the fuel, in particular the fuel gas, is supplied into the transition between the preheating zone 32, 34 and the burning zone 50, 52 via the lances 40, 42.

### LIST OF REFERENCE DESIGNATIONS

10 PFR shaft kiln
12, 14 Shaft
16, 18 Material inlet
20, 22 Fuel inlet
24, 26 Material outlet
28, 30 Cooling air inlet
32, 34 Preheating zone
36, 38 Upper boundary surface of the preheating zone
40, 42 Lances
44 Refractory lining
46, 48 Lower boundary surface of the preheating zone/upper boundary surface of the burning zone
50, 52 Burning zone
54 Gas channel
56, 58 Lower boundary surface of the burning zone/upper boundary surface of the cooling zone
60, 62 Cooling zone
64, 66 Gas lances
68, 70 Discharge device
72 Burning cycle time
74 Fuel supply time
76 Preliminary flushing time
78 Subsequent flushing time
80 Reversal time
82, 84 Gas collection channel
86, 88 Bar
90, 92 Annular space

1.-15. (canceled)

16. A method for burning and cooling material in a parallel flow-counter flow regenerative shaft kiln that includes two shafts that are operated alternately as a burning shaft and as a regenerative shaft, wherein the material flows through a preheating zone, a burning zone, and a cooling zone to a material outlet, wherein fuel is supplied inside or above the preheating zone such that the fuel is heated in the preheating zone prior to the fuel entering into the burning zone.

17. The method of claim 16 comprising supplying oxidation gas into the burning zone.

18. The method of claim 16 wherein the fuel has a calorific value of 1 MJ/Nm³ to 7 MJ/Nm³.

19. The method of claim 16 comprising introducing oxidation gas into the burning zone via a multiplicity of lances or slots in a shaft wall.

20. The method of claim 16 wherein arranged at a transition between the preheating zone and the burning zone is a flow resistance for generating a volume region without material to be burned, wherein oxidation gas is introduced into the volume region.

21. The method of claim 16 comprising introducing oxidation gas into an annular space arranged around a transition between the preheating zone and the burning zone.

22. The method of claim 16 wherein one of the two shafts is operated as the burning shaft over a length of time of a burning cycle, wherein the method comprises the following steps during the burning cycle:
a) supplying the fuel through a fuel inlet into the burning shaft over a time interval of a fuel supply time;
b) supplying an inert gas through the fuel inlet into the burning shaft over a preliminary flushing time;
c) supplying a low-oxygen gas through the fuel inlet into the burning shaft over a subsequent flushing time; and
d) reversing the kiln operation by reversing functions of the burning shaft and of the regenerative shaft.

23. The method of claim 22 wherein, during the preliminary flushing time and/or the subsequent flushing time, the method comprises introducing an oxidation gas into the burning shaft via lances and/or slots in a shaft wall.

24. A parallel flow-counter flow regenerative shaft kiln for burning and cooling material, the parallel flow-counter flow regenerative shaft kiln including two shafts that are each configured to be operated alternately as a burning shaft and as a regenerative shaft, wherein each of the two shafts includes, in a direction of flow of the material, a preheating zone for preheating the material, a burning zone for burning the material, and a cooling zone for cooling the material, wherein a fuel inlet for admitting fuel into each shaft is arranged above or inside the preheating zone.

25. The parallel flow-counter flow regenerative shaft kiln of claim 24 wherein a multiplicity of lances or slots in a shaft wall for introducing oxidation gas are arranged inside the burning zone.

26. The parallel flow-counter flow regenerative shaft kiln of claim 24 wherein a multiplicity of gas lances for introducing oxidation gas are arranged inside the burning zone, inside the cooling zone, and/or inside a gas channel for connection of the two shafts.

27. The parallel flow-counter flow regenerative shaft kiln of claim 24 wherein arranged at a transition between the preheating zone and the burning zone is a flow resistance for generating a volume region without material to be burned.

28. The parallel flow-counter flow regenerative shaft kiln of claim 24 wherein an annular space is formed around a transition between the preheating zone and the burning zone, wherein a volume region without material to be burned is formed inside the annular space.

29. The parallel flow-counter flow regenerative shaft kiln of claim 28 wherein means are arranged for introducing oxidation gas into the volume region without material to be burned.

30. The parallel flow-counter flow regenerative shaft kiln of claim 24 wherein each shaft includes a respective gas collection channel that is configured as an annular space, wherein the gas collection channels of the two shafts are connected to one another in terms of gas technology via a gas channel.
